(19) United States
(12) Patent Application Publication
(10) Pub. No.: US 2002/0170808 A1
(43) Pub. Date: Nov. 21, 2002

(54) Interlock device

(76) Inventor: Takahiko Takano, Yamanashi (JP)

Correspondence Address: McGinn & Gibb, PLLC, Suite 200, 8321 Old Courthouse Road, Vienna, VA, 22182-3817, US

(21) Appl. No.: 10/141,964

(22) Filed: May 10, 2002

(30) Foreign Application Priority Data
May 16, 2001 (JP) 2001-147046

(51) Int. Cl. H01H 9/20

(52) U.S. Cl. 200/50.02

(57) ABSTRACT

An interlock device for a casing of double door structure can enable power supply with one switch only when both doors are closed. The interlock device includes a lever pivotably supported at an intermediate portion and being pivoted in a predetermined direction as pushed one end portion by the first door when the first door is closed, a link member responsive to pivot motion of the lever to the predetermined position and driven by the other end of the lever to be moved from a first position on the side of the first door to a second position on the side of the second door, a pushing member mounted on the link member and responsive to closure of the second door while the link member is placed at the second position, to be pushed into a third position, and a switch responsive to the pushing member placed at the third position to turn ON power supply for the apparatus.

### BACKGROUND OF THE INVENTION

1. Field of the Invention

The present invention relates to an interlock device for turning ON a power source of a device housed within a casing when both of hinged double doors are closed.

2. Description of the Related Art

Many of apparatus, such as control panel and so on, are housed within housing with a door. When the apparatus is in operation, the door of the casing is held closed. Upon maintenance and inspection of the apparatus and replacement of consumable articles and so forth, the power supply is turned OFF and the door is opened to perform necessary operation. In such apparatus, in order to avoid occurrence of misstep of turning ON of power supply while the door is held open or misstep of opening of door while the apparatus is in operation, an interlock device for enabling power supply to the apparatus only when the door is closed, is provided. The interlock device is provided with an interlock switch (hereinafter simply referred to as switch). The switch is held ON while the door is held closed, for enabling power supply to the apparatus.

On the other hand, among various casings, there are some casings of the type having two doors for one opening, such as hinged double door, for example. The casing of this type is advantageous for motion area of the door in comparison with the size of the opening portion.

When the interlock device is provided for such type of casing, there is a method to provide switches in number equal to number of the doors, in the interlock device and mount the switches for each door. On the other hand, it is also possible to provide only one switch for the interlock device for providing the switch on one door.

However, such prior art encounters the following problems. In case of the method providing the switch per the door, number of switches is increased to make a cost of the interlock device higher. As a result, cost of the overall apparatus, such as control panel or so forth, is significantly influenced.

On the other hand, in case of the method providing only one switch for one of the doors, the power may be supplied while the door provided with the switch is closed, irrespective of the position of other doors. Thus, such approach encounters a problem in viewpoint of security.

### SUMMARY OF THE INVENTION

The present invention has been worked out in view of the drawbacks set forth above. It is an object of the present invention to provide an interlock device for a casing of double door structure, which can enable power supply with one switch only when both doors are closed.

According to one aspect of the present invention, an interlock device applicable for a casing having an opening opened and closed by a first door and a second door in hinged double door construction for supply power to an apparatus housed within the casing when both of the first door and the second door are closed, comprises:

a lever pivotably supported at an intermediate portion and being pivoted in a predetermined direction as pushed one end portion by the first door when the first door is closed;

a link member responsive to pivot motion of the lever to the predetermined position and driven by the other end of the lever to be moved from a first position on the side of the first door to a second position on the side of the second door;

a pushing member mounted on the link member and responsive to closure of the second door while the link member is placed at the second position, to be pushed into a third position; and

a switch responsive to the pushing member placed at the third position to turn ON power supply for the apparatus.

As set forth above, in the present invention, the link member is moved from the first position to the second position by closing the first door. Then, by closing the second door, the pushing member is pushed into the third position to turn the switch ON by the pushing member. Thus, with one switch, the power is supplied to the apparatus only when both of the first and second doors are closed.

In the preferred construction, the pushing member may be mounted on the link member in such a manner that a direction of movement as pushed intersects with moving direction of the link member.

On the other hand, the pushing member may be constantly placed at a fourth position and may be pushed to move when the second door is closed, and a first resilient member biasing the pushing member toward the fourth position may be provided between the link member and the pushing member.

Also, the first and second doors may be pivoted about horizontal shafts, the opening portion may be arranged at the front side of the casing, and the lever may be pivotable about a horizontal shaft, the first position may be arranged lower than the second position, and the link member may be constantly biased toward the first position by gravity.

The interlock device may further comprise a second resilient member provided between the casing and the link member and constantly biasing the link member toward the first position.

Preferably, the lever may be bent at a pivot portion pivotably supported on the horizontal shaft so that one portion and the other portion extend in mutually different directions, and side edges of the one portion and the other portion to be pushed by the first door intersect at an angle greater than 180°.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a side elevation showing the preferred embodiment of an interlock device according to the present invention illustrating a condition where both of two doors are opened;

FIG. 2 is a side elevation showing the preferred embodiment of the interlock device according to the present invention illustrating a condition where only one of the two doors is closed; and

FIG. 3 is a side elevation showing the preferred embodiment of the interlock device according to the present invention illustrating a condition where the other door is also closed from the condition shown in FIG. 2.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

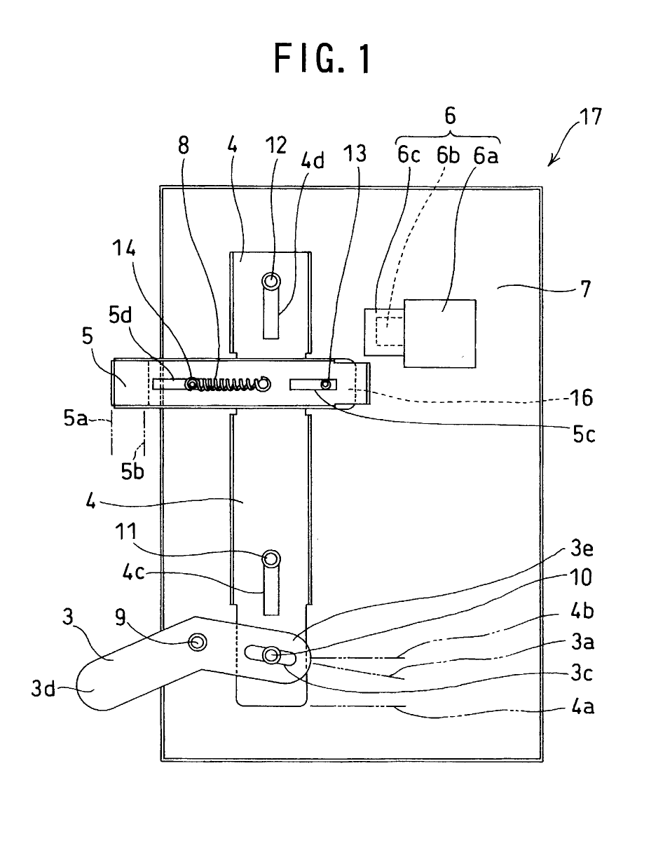

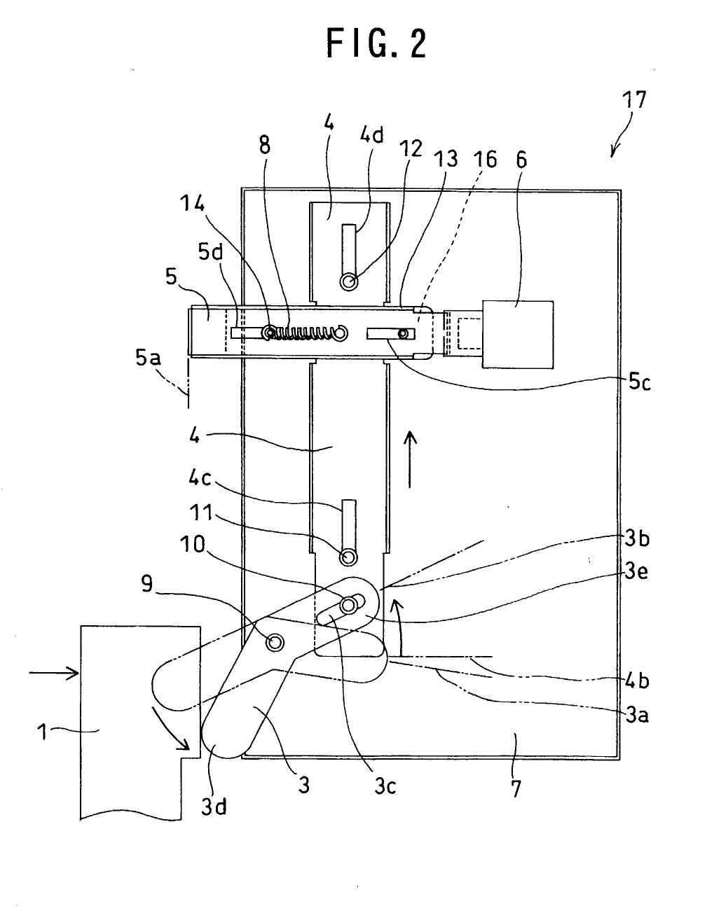

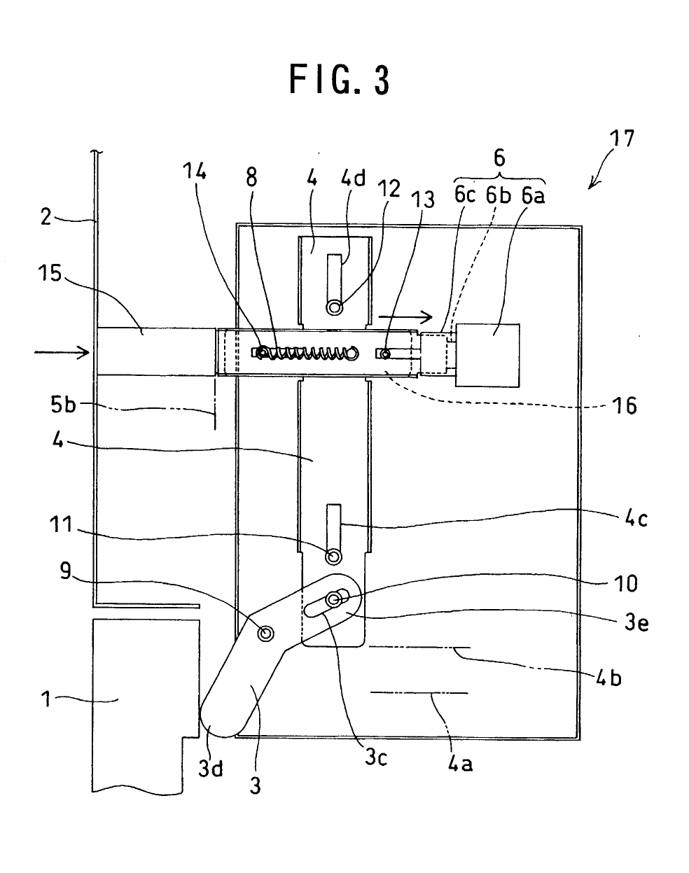

FIGS. 1 to 3 are side elevation of the preferred embodiment of an interlock device according to the present invention. In a casing (not shown) for housing an apparatus, such as a control panel or the like (not shown), a quadrangular opening portion (not shown) is provided in the front side for maintenance and inspection of the apparatus. The opening portion is opened and closed by two doors 1 and 2 shown in FIG. 3. FIG. 1 shows a condition where both of two doors 1 and 2 are opened, FIG. 2 shows a condition where only one door 1 is closed and the other door 2 is closed, and FIG. 3 shows a condition where both doors 1 and 2 are closed.

The door 1 is hinged on a horizontal shaft extending along the lower edge of the opening portion of the casing, and the door 2 is hinged on a horizontal shaft extending along the upper edge, namely the edge opposing to the edge on which the door 1 is hinged. The doors 1 and 2 are opened and closed about the horizontal shafts in hinged double door fashion. On the door 2, a projecting portion 15 is locally provided on the inner surface (see FIG. 3). On the other hand, within the casing, in the vicinity of the position where the tip ends of the doors 1 and 2 mate in the opening portion, an interlock device 17 according to the present invention is provided.

As shown in FIG. 1, in the interlock device 17, a quadrangular plate form base plate 7 is rigidly secured on the casing with orienting a mounting plane. On the lower portion of the base plate 7, a rotary shaft 9 is horizontally secured. On the rotary shaft 9, an intermediate portion of a lever 3 is supported so that the lever 3 may pivot about the rotary shaft 9. The lever 3 is bent at the intermediate portion to differentiate orientation in one side portion 3d and the other side portion 3e across the pivoted portion pivoted on the rotary shaft 9. Among a pair of side edges of the lever 3, one side edge intersecting at an angle greater than 180° (the edge located closer to the doors) opposes to the door 1 at an end portion to be pushed by the door 1. On the other hand, at a tip end portion of the other side portion 3e, an elliptic slit 3c extending in the direction along which the other side portion 3e extends, is provided.

On the other hand, studs 11 and 12 are mounted on the base plate 7. The stud 11 is located in vertical alignment with the stud 12. On the studs 11 and 12, s link member 4 is mounted. The link member 4 is a vertically extending strip form. In a lower portion and an upper portion of the link member 4, vertically extending rectangular slits 4c and 4d are provided. The studs 11 and 12 are engaged with respective slits 4c and 4d so that the link member 4 may move from a position 4a to a position 4b. Namely, studs 11 and 12 are moved relatively within the slits 4a and 4d. It should be noted that the position 4a is located lower side of the position 4b, namely on the side of the door 1. As set forth above, the link member 4 is mounted on the base plate 7 via the studs 11 and 12.

Furthermore, on the lower side of the slit 4c in the link plate 4, a stud 10 is mounted. The stud 10 engages with the slit 3c of the lever 3 for sliding movement. By this, the link member 4 engages with the lever 3 to cause vertical movement of the link member 4 by pivot motion of the lever 3. Normally, the link member 4 is located at the position 4a by gravity. At this time, the one side portion 3d of the lever 3 is projected outside of the base plate 7. The other side portion 3e of the lever 3 is located at the position 3a. At this condition, when the door 1 (see FIG. 3) is closed, the door 1 pushes the one side portion 3d of the lever 3 for pivoting the lever 3 about the rotary shaft 9.

On the other hand, between the slits 4c and 4d in the link member 4a guide plate 16 extending in horizontal direction is mounted. On the guide plate 16, studs 13 and 14 are mounted.

On the other hand, in the interlock device 17, a pushing member 5 is provided. The pushing member 5 has a horizontally extending strip shape. In the pushing member 5, horizontally extending rectangular slits 5c and 5d are provided. The studs 13 and 14 on the guide plate 16 are engaged with respective slits 5c and 5d for relative movement with respect to the slits 5c and 5d. Thus, the pushing member 5 is movable in the longitudinal direction of the guide plate 16, namely movable from a position 5a to a position 5b. On the other hand, between the guide plate 16 and the pushing member 5, a bias spring 8 is provided for biasing the pushing member 5 toward the position 5a. By this, when a load is not applied to the pushing member 5, the pushing member 5 is placed at the left side end in the motion range, namely at the position 5a.

Also, the switch 6 is rigidly secured on the base plate 7. The switch 6 is adapted to supply electric power to the apparatus, such as the control panel or the like, when the switch 6 is depressed. The switch 6 is constructed with a main body 6a, a pushing portion 6b and a cover 6c covering the pushing portion 6b. The pushing portion 6b of the switch 6 is arranged at a position to be depressed by the pushing member 5 when the link member 4 is moved to the upper end of the motion range, namely moved at the position 4b, and the pushing member 5 is moved to the right side end in the motion range, namely at the position 5b.

Next, discussion will be given for operation of the interlock device 17. As shown in FIG. 1, when both of the doors 1 and 2 are opened, the link member 4 is placed at the lowermost position in the motion range, namely the position 4a by weights of the link member 4, the guide plate 16 and the pushing member 5. At this time, the one side portion 3d of the lever 3 is projected from the base plate 7. Then, the other side portion 3e of the lever 3 is placed at the position 3a. On the other hand, the pushing member 5 is biased by a resilient force of the spring 8 to place at the position 5a. At this condition, even when the door 2 is closed, the pushing member 5 cannot push the pushing portion 6b of the switch 6.

Next, as shown in FIG. 2, by closing the door 1, the tip end of the one side portion 3d of the lever 3 is pushed by the door 1. Then, the lever 3 is pivoted in counterclockwise direction in the drawing to move the tip end portion of the other side portion 3e from the position 3a to the position 3b. Associating with pivotal movement of the lever 3, the stud 10 of the link member 4 is slid within the slit 3c of the lever 3 to push the link member 4 upward. By this, the link member 4 is moved from the position 4a to the position 4b. At this time, the studs 11 and 12 are relatively slid within the slits 4a and 4b to serve as guide for the link member 4. By placing the link member 4 at the position 4b, the guide plate 16 and the pushing member 5 are also moved. As a result, the height of the pushing member 5 becomes equal to the height of the switch 6.

Next, as shown in FIG. 3, by further closing the door 2, the projecting portion 15 of the door 2 is pushed by the pushing member 5. By this, the pushing member 5 is moved from the position 5a to the position 5b against the resilient force of the spring 8. At this time, the studs 13 and 14 are relatively slid within respective slits 5c and 5d to serve as guide for movement of the pushing member 5. By movement of the pushing member 5 to the position 5b, the pushing member 5 pushes the pushing portion 6b of the switch 6 to turn ON the switch. Thus, power is supplied to the apparatus.

As set forth above, in the shown embodiment of the interlock device, the construction is taken so that the pushing portion 6b of the switch 6 cannot be depressed unless the door 1 is closed at first and then the door 2 is closed. Namely, only when both of the doors 1 and 2 are closed, the power is supplied to the apparatus. When at least one of the doors 1 and 2 is open, the power is never supplied to the apparatus. Even when both doors are closed, the switch 6 cannot be pushed unless the door is closed at first and then the door is closed. Namely, the power is not supplied to the apparatus unless the doors 1 and 2 are closed in predetermined procedure. As set forth above, the shown embodiment of the interlock device certainly prevents turning ON of power supply when at least one of two doors is opened. As a result, misstep of turning On of the power supply for the apparatus in the condition where at least one door is opened or misstep of opening of at least one door during operation of the apparatus, can be certainly prevented. Also, in the shown embodiment of the interlock device, such function can be realized by one switch.

On the other hand, since the edges of the lever 3 on the side intersect at the angle greater than 180° to be pushed by the door 1, the lever 3 is pushed by the door 1 when the door 1 is closed. By rotation of the lever 3, motion of the door 1 can be converted into vertical linear motion of the link member 4, effectively.

It should be noted that, in the shown embodiment, the position 4a is arranged at the lower portion than the position 4b. Therefore, when the door 1 is opened, the link member 4, the guide plate 16 and the pushing member 5 are stacked to place the link member 4 at the position 4a. By this, it becomes unnecessary to locate the position 4a at lower position than the position 4a to increase freedom in arranging the interlock device 17.

As set forth above, with the present invention, it becomes possible to obtain the interlock device provided in the casing having two doors and housing the apparatus, in which the power is supplied to the apparatus only when both of two doors are closed. By this, turning ON the power supply for the apparatus in the condition where the door is opened or opening of the door during operation of the apparatus can be prevented. Thus, security in maintenance and inspection of the apparatus, in replacement of parts and in operation can be improved.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An interlock device applicable for a casing having an opening opened and closed by a first door and a second door in hinged double door construction for supply power to an apparatus housed within said casing when both of the first door and the second door are closed, comprising:
a lever pivotably supported at an intermediate portion and being pivoted in a predetermined direction as pushed one end portion by said first door when said first door is closed;
a link member responsive to pivot motion of said lever to said predetermined position and driven by the other end of said lever to be moved from a first position on the side of said first door to a second position on the side of said second door;
a pushing member mounted on said link member and responsive to closure of said second door while said link member is placed at said second position, to be pushed into a third position; and
a switch responsive to said pushing member placed at said third position to turn ON power supply for said apparatus.

2. An interlock device as set forth in claim 1, wherein said pushing member is mounted on said link member in such a manner that a direction of movement as pushed intersects with moving direction of said link member.

3. An interlock device as set forth in claim 1, wherein said pushing member is constantly placed at a fourth position and is pushed to move when said second door is closed, and a first resilient member biasing said pushing member toward said fourth position is provided between said link member and said pushing member.

4. An interlock device as set forth in claim 1, wherein said first and second doors are pivoted about horizontal shafts, said opening portion is arranged at the front side of said casing, and said lever is pivotable about a horizontal shaft, said first position is arranged lower than said second position, and said link member is constantly biased toward said first position by gravity.

5. An interlock device as set forth in claim 1, which further comprises a second resilient member provided between said casing and said link member and constantly biasing said link member toward said first position.

6. An interlock device as set forth in claim 1, wherein said lever is bent at a pivot portion pivotably supported on said horizontal shaft so that one portion and the other portion extend in mutually different directions, and side edges of said one portion and the other portion to be pushed by said first door intersect at an angle greater than 180°.
